(19) United States
(12) Patent Application Publication
(10) Pub. No.: US 2017/0099363 A1
(43) Pub. Date: Apr. 6, 2017

(54) Electronic virtual sports scoreboard system that provides event alerts, video highlights and statistics to social media and other web-based distributions systems with minimal effort required of the scorekeeper

(71) Applicants: Gary David Baldyga, Severna Park, MD (US); Tracy A. Hoover, Davidsonville, MD (US)

(72) Inventors: Gary David Baldyga, Severna Park, MD (US); Tracy A. Hoover, Davidsonville, MD (US)

(21) Appl. No.: 14/875,681

(22) Filed: Oct. 5, 2015

(51) Int. Cl. H04L 29/08; G06F 3/0484

(52) U.S. Cl. CPC H04L 67/26; G06F 3/04842; H04L 67/12

(57) ABSTRACT

A system for scoring and timing sports events that maximizes fan experience through virtual access to statistics, real-time scoring, and significant event alerts with video by social media or Internet web access—with minimal extra work required so that a single scorekeeper can run the system. Watching the event live by streaming video is also an option.

### CROSS REFERENCES

### None

### FEDERALLY SPONSORED RESEARCH

### None

### NAMES FOR JOINT RESEARCH

### None

### SEQUENCE LISTING

### None

### BACKGROUND OF THE INVENTION

The idea behind this invention is to give the fans of small school or club teams an enhanced experience, much like that available for major league sports fans on mobile devices, without requiring multiple people to run the system. Sports fans at major league and major college events have a wealth of information regarding the event available by various applications on handheld mobile devices, such as tablets and smart phones. These apps are fed information by large teams of media personnel who cover the event for major sports networks. Small schools and sports clubs simply cannot afford to hire large numbers of people to feed information to an a sports app, and they might not have a contract with a sports media network. But with the advent of modern mobile and wireless devices, high-tech cameras, and the ubiquitous nature of social media, it is possible for schools and clubs to provide fans with an enhanced fan experience with a system that can be operated by just the one person that normally runs the scoreboard. Schools and clubs usually provide a scorekeeper or two for sporting events. This invention takes the inputs the scorekeeper would make to a scoreboard and uses those inputs to run a system that not only runs the physical scoreboard next to the field or on the wall of the gymnasium, but provides a virtual scoreboard that may be viewed on mobile devices from any location. This is handy when there is no physical scoreboard, the scoreboard is not working, or if the fan is not at the event and wants to keep up with the score. This system sends automatic alerts via text message or social media at menu-selected times or events during the event, including links to audio-video clips of the action. Fans at the event would have at their fingertips statistics of players and teams. They would be able to replay the action to see a big play or close call—right in the stands with a smart phone or tablet, or from any location where they have an Internet connection, either on a computer of on a wireless device that receives wireless data. If the school or club provides the bandwidth, fans could even watch the action live from any computer or mobile device—anywhere. Fans could select from a menu the name of the player or team they want to follow, and they would receive alerts when that person or team is going to play, or when that person or team scores or finishes a contest. Data such as tournament brackets are updated automatically from the scorekeeper inputs. Event printouts are available for certification with referees. All of these features are possible with the same number of people that would normally run a scoreboard for the event, with perhaps one more person to bound video clips in time and field of view before they are pushed from the app. The app could be purchased from an app store on any device. Sponsor advertisements would run on the app, much as they do on the websites of most school or club teams. The school or club would have to invest in the system with cameras and would have to purchase bandwidth to cover the field or gymnasium with a wi-fi signal. But fans would have an enhanced experience without the need for a large number of media personnel to push content to the mobile app.

### BRIEF SUMMARY OF INVENTION

A system and method for utilizing wireless handheld devices or computers to score and time sports events, control physical and virtual scoreboards, make event updates and video available by social media or the Internet, and update a database of statistics that is available in real time to fans. The System can be paired with cameras and microphones in order to push video and audio with alerts by social media and to a database that makes the video clips accessible by the Internet. The system uses software to process normal scorekeeper inputs and uses them not only to control the scoreboard, but also to drive database updates and social media alerts without requiring any additional effort from the scorekeeper. With a small additional effort, the scorekeeper can attach video clips to the alerts. System allows the game clock to be controlled on the field by wireless device. With enough bandwidth provided at the event, system provides access to live video by either wireless device or Internet website in order to allow fans to watch the event in real time.

### Inventors

Gary Baldyga, Severna Park, Maryland

Tracy Hoover, Davidsonville, Maryland

Todd Raines, Edgewater, Maryland

### DETAILED DESCRIPTION OF INVENTION

1. A system and method for keeping score of live sporting events which provides an immersive experience for the fan by making all aspects of the event information available in any location as a result of inputs made on interfaces accessed on mobile devices:
A. An interface for a scorekeeper, which may be combines with . . .
B. An interface for a timekeeper;
C. An interface for a video editor.

2. A method for utilizing a software application on a wireless handheld device (e.g., smart phone or tablet) that interfaces with the system that allows scorekeepers, time keepers, game officials, reporters, or staff to enter game events which cause a combination of the following to automatically happen:
A. Update the game data displayed on a physical scoreboard;
B. Update the game data displayed on a virtual scoreboard;
C. Send game status updates to social media or to an Internet website;
D. Update a database of team and individual statistics to make relevant information available to virtual and real spectators to enhance the event experience;
E. Control the game clock from the scorekeeper's handheld device.

3. A system and method to allow an on-field official or scorekeeper to control the game clock by making inputs to a software application on a wireless handheld device (e.g., smart phone or tablet).

4. A process to allow video-plus-audio clip selection: The data from the software application detailed in claim 3 will feed data into a system that pairs it with video/audio recordings of the game action recorded by one or more cameras and microphones. Video/audio clips may be selected from the recorded game data by an operator using an index automatically generated by the events entered into the software application, time stamps on the data from the software application, and event descriptions originating from selections made in the software application (e.g., a score, the end of a period of play).

5. The following optional features of the clip selection process described in claim #4:
A. The operator generating the clips may optionally adjust the parameters to create a clip that will be published to social media or a website. Adjustments may be selected to bound video/audio clips in time and field of view (i.e., selecting a small frame from a larger sized video).
B. Clips from the video editor can be automatically pushed to social media and Internet websites.
C. Hyperlinks to the video clips generated by this process may be pushed to social media sites or websites
D. The video selection program can add text tags to data pushed to social media, a website, or an archival database. These tags may be used for applications such as allowing a user to ‘filter’ and see only the actions of selected players, for tracking player statistics, or to build ‘portfolios’ of player activity.

6. Event milestones (e.g., scoring events, end of periods of play, events involving a particular player) can be selected by a menu to generate automatic social media updates of the event, based on scorekeeper and timekeeper inputs.

7. System and method allows control of sporting event information, as in claims 1-6, for live events of the following sports: football, basketball, lacrosse, baseball, volleyball, wrestling, field hockey, swimming, soccer, bocce, golf, indoor and outdoor track, cross country, hockey, and tennis, as wells as live events of a non-sports nature (e.g., music concerts, conferences) at the selection of the user and according to the events made available by the schools or clubs subscribing to the system.

8. The system provides control of meaningful live event information, in accordance with claims 1-7 with the following features, by sport:
A. For the sport of football: Automatic event alerts are sent by social media or to an Internet website for ends of time period, scores, changes of possession.
B. For the sport of basketball:
   1) Automatic event alerts are sent by social media or to an Internet website for ends of time period and changes of scoring lead.
   2) During the final two minutes of play, updates are sent for all scores.
C. For the sport of lacrosse:
   1) Virtual scoreboard includes information when a penalty is called, team and player called for penalty, time in the penalty box.
   2) Scorekeeper interface provides selections for scorekeeper to input penalty information.
   3) Automatic event alerts with links to audio-video clips are sent by social media or to an Internet website for ends of time period and all scoring plays.
D. For the sport of baseball: Automatic event alerts are sent by social media or to an Internet website for the end of every half inning and alerts with links to audio-video clips are set for all scoring plays.
E. For the sport of volleyball: Automatic event alerts are sent by social media or to an Internet website for ends of games and all lead changes.
F. For the sport of wrestling:
   1) Subscribers can enter the name(s) of the wrestler(s) or team(s) they want to follow; subscribers will receive alerts by text or social media when the selected wrestler or team is about to wrestle and the mat where the match will occur.
   2) Automatic event alerts with links to complete-match audio-video clips are sent for selected wrestler(s) by social media or to an Internet website for ends of individual matches.
   3) Automatic event alerts are sent by social media or to an Internet website for ends of tournaments.
G. For the sport of field hockey:
   1) Virtual scoreboard includes information when a penalty is called, team and player called for penalty, time in the penalty box.
   2) Scorekeeper interface provides selections for scorekeeper to input penalty information.
   3) Automatic event alerts with links to audio-video clips are sent by social media or to an Internet website for ends of time period and all scoring plays.
H. For the sport of swimming:
   1) Subscribers can enter the name(s) of the swimmer(s) or team(s) they want to follow; subscribers will receive alerts by text or social media when the selected swimmer or team is about to swim, the lane(s) assigned, and the names and teams of competing swimmers.
   2) Automatic event alerts with links to event audio-video clips are sent for selected swimmer(s) or team(s) by social media or to an Internet website for ends of individual races for which either a swimmer or team selected participated.
   3) Swim meet brackets are updated as races are recorded by the scorekeeper.
   4) Automatic event alerts are sent by social media or to an Internet website for ends of swim meets.
I. For the sport of soccer:
   1) Virtual scoreboard includes information when a penalty is called, team and player called for penalty, and information on resulting penalty kicks.
   2) Scorekeeper interface provides selections for scorekeeper to input penalty information.
   3) Automatic event alerts with links to audio-video clips are sent by social media or to an Internet website for ends of time period and all scoring plays.
J. For the sport of bocce:
   1) Subscribers can enter the name(s) of the individual(s) or team(s) they want to follow; subscribers will receive alerts by text or social media when the selected individual or team is about to compete and the names of competing individuals and teams.
2) Automatic event alerts with links to event audio-video clips are sent for selected individuals(s) or team(s) by social media or to an Internet website for ends of individual rounds and matches for which either an individual or team selected participated.
   3) Automatic event alerts are sent by social media or to an Internet website for ends of tournaments.
K. For the sport of golf:
   1) Subscribers can enter the name(s) of the individual(s) or team(s) they want to follow; subscribers will receive alerts by text or social media when the selected individual or team is about to compete and the names of competing individuals and teams.
   2) Automatic event alerts with links to event audio-video clips are sent for selected individuals(s) or team(s) by social media or to an Internet website for ends of individual rounds of nine holes, or for completed rounds of 18 holes for which either an individual or team selected participated.
   3) Automatic event alerts are sent by social media or to an Internet website for changes to the leader board.
L. For the sport of track:
   1) Subscribers can enter the name(s) of the individual(s) or team(s) they want to follow; subscribers will receive alerts by text or social media when the selected individual or team is about to compete and the names of competing individuals and teams.
   2) Automatic event alerts with links to event audio-video clips are sent for selected individuals(s) or team(s) by social media or to an Internet website for ends of individual events or races for which either an individual or team selected participated.
   3) Track meet brackets are updated as events or races are recorded by the scorekeeper.
   4) Automatic event alerts are sent by social media or to an Internet website for ends of track meets.
M. For the sport of cross country:
   1) Subscribers can enter the name(s) of the runner(s) or team(s) they want to follow; subscribers will receive alerts by text or social media when the selected runner or team is about to compete and the names of competing teams.
   2) Automatic event alerts with links to event audio-video clips are sent for selected runner(s) or team(s) by social media or to an Internet website for ends of individual races for which either a runner or team selected participated.
   3) Cross country meet brackets are updated as races are recorded by the scorekeeper.
   4) Automatic event alerts are sent by social media or to an Internet website for ends of races and meets.
N. For the sport of tennis:
   1) Subscribers can enter the name(s) of the player(s) or team(s) they want to follow; subscribers will receive alerts by text or social media when the selected player or team is about to play and the court where the match will occur.
   2) Automatic event alerts with links to last point audio-video clips are sent for selected player(s) by social media or to an Internet website for ends of individual sets or matches.
   3) Automatic event alerts are sent by social media or to an Internet website for ends of tournaments.
   O. For the sport of hockey:
1) Virtual scoreboard includes information when a penalty is called, team and player called for penalty, time in the penalty box.
2) Scorekeeper interface provides selections for scorekeeper to input penalty information.
3) Automatic event alerts with links to audio-video clips are sent by social media or to an Internet website for ends of time period and all scoring plays.

9. System produces menu-selectable combinations of individual, team or event statistics, which can be viewed and printed out from a computer and printer, or viewed from a mobile device live at the event.

10. System updates brackets for events, tournaments or league standings automatically from scorekeeper inputs.

11. System includes software that processes the outputs of high-definition video cameras that keep the entire playing field or court in view at all times, alleviating the need for a camera operator to pan the camera. Video clips can be bound in field of view and time by the scorekeeper using the system before pushing clips by social media or the Internet. If school or club provides bandwidth, live action video is available from the system.

1. This invention includes a new and useful process whereby a scorekeeper at a sports event, making the normal inputs that would normally operate a scoreboard, is assisted by software so that content about the event is automatically pushed to the Internet and social media, without extra inputs or work performed by the scorekeeper. The inputs of the scorekeeper make a virtual scoreboard available to fans on mobile devices or computers on the Internet, providing the same kinds of event information that would be displayed on a physical scoreboard.

2. When paired with video equipment, the invention software makes it easy for the scorekeeper to add video clips to the updates and alerts that are sent out from the event. The invention makes it possible for the single scorekeeper to provide video content, saving the expense of having additional people working the event for video support.
The invention enables a game official on the field of play to control the clock on the physical and virtual scoreboards from a small mobile device such as a smart phone or tablet.
